(19) United States
(12) Patent Application Publication
(10) Pub. No.: US 2013/0140935 A1
(43) Pub. Date: Jun. 6, 2013

(54) Slot Liner and Interphase Insulator Combination

(71) Applicant: Martin Houle, Laval (CA)

(72) Inventor: Martin Houle, Laval (CA)

(21) Appl. No.: 13/266,293

(22) PCT Filed: Jun. 10, 2010
(86) PCT No.: PCT/CA10/00905

§ 371 Date: Dec. 6, 2011

Related U.S. Application Data
(60) Provisional application No. 61/213,642, filed on Jun. 29, 2009.

(51) Int. Cl. H02K 3/34

(52) U.S. Cl. CPC H02K 3/345
USPC 310/215

(57) ABSTRACT

Electrically insulating material so foldable as to form a slot liner and an interphase insulator combination so configured as to be inserted in the slots of the stator or the rotor of an electric machine to prevent coils from being in contact with the slot walls and to prevent separate coils inserted in the same slot to be in direct contact with one another is described herein.

### FIELD

The present invention generally relates to electric machines. More specifically, the present invention is concerned with a slot liner and interphase insulator combination so configured as to be inserted in the rotor and/or stator slots of an electric machine.

### BACKGROUND

Stators and rotors of electric machines are routinely made of a stack of laminations provided with coil receiving slots defined by projecting teeth therebetween. These slots need to be electrically insulated from the coils that are to be inserted therein. Insulating paper material has been developed for this purpose.

Conventionally, rolls of such insulating paper are cut and folded to form individual slot liners that are manually or automatically inserted into the slots. These liners are often U shaped with arms that are sized to extend out of the slot and thus help guide the coil therein while preventing the contact between the coil and the stack of laminations. Once a first coil is inserted in the slot, an interphase insulator, in the form of another layer of insulating paper material, is placed on top of the first coil before a second coil is inserted in the slot. The interphase insulator ensures that there is adequate electric insulation between the two or more phases sharing the slot.

The excess material of the slot liners is removed or folded on top of the second coil and a slot closing member is inserted in the slot.

Many drawbacks are associated with this method of forming and installing slot liners. Indeed, manipulating both slot liners and interphase insulators is cumbersome.

### BRIEF DESCRIPTION OF THE DRAWINGS

In the appended drawings:

FIG. 1 is a perspective view of a foldable slot liner and interphase insulator combination according to an illustrative embodiment;

FIGS. 2 to 8 are sectional views illustrating the various steps in the installation of the slot liner and interphase insulator combination of FIG. 1 in a slot of a stator; and

FIG. 9 is a sectional perspective view of a portion of an assembled stator including slot liner and interphase insulator combinations of FIG. 1.

### DETAILED DESCRIPTION

Generally stated, illustrative embodiments are concerned with electrically insulating paper so foldable as to form a slot liner and interphase insulator combination for the slots of the stator or rotor of an electric machine.

More specifically, in accordance to an illustrative embodiment, there is provided a slot liner and interphase insulator made of an insulating material and configured and sized to enter the longitudinal slot of an electric machine and to electrically insulate a first and a second coil from one another and from the electric machine; the insulator comprising:

a short side wall;

a bottom wall; and

along foldable side wall including three longitudinal fold lines defining first, second, third and fourth long side wall portions;

wherein, when the slot liner and interphase insulator is inserted in the slot of an electric machine, a) the first long side wall portion insulates a portion of the first coil from the electric machine; b) the second and third long side wall portions insulate the first and second coils from one another, and c) the fourth long side wall portion insulates a portion of the second coil from the electric machine.

In accordance with another aspect, there is provided a slot liner and interphase insulator made of an insulating material and configured and sized to enter the longitudinal slot of an electric machine and to electrically insulate a first and a second coil from one another and from first and second side walls and a bottom wall of the longitudinal slot, the insulator comprising:

a short side wall so configured and sized as to insulate the first side wall of the slot;

a bottom wall so configured and sized as to insulate the bottom wall of the slot; and

a long side wall so configured and sized as to insulate the second side wall of the slot and to be folded to define an interphase insulator insulating the first and second coils from one another.

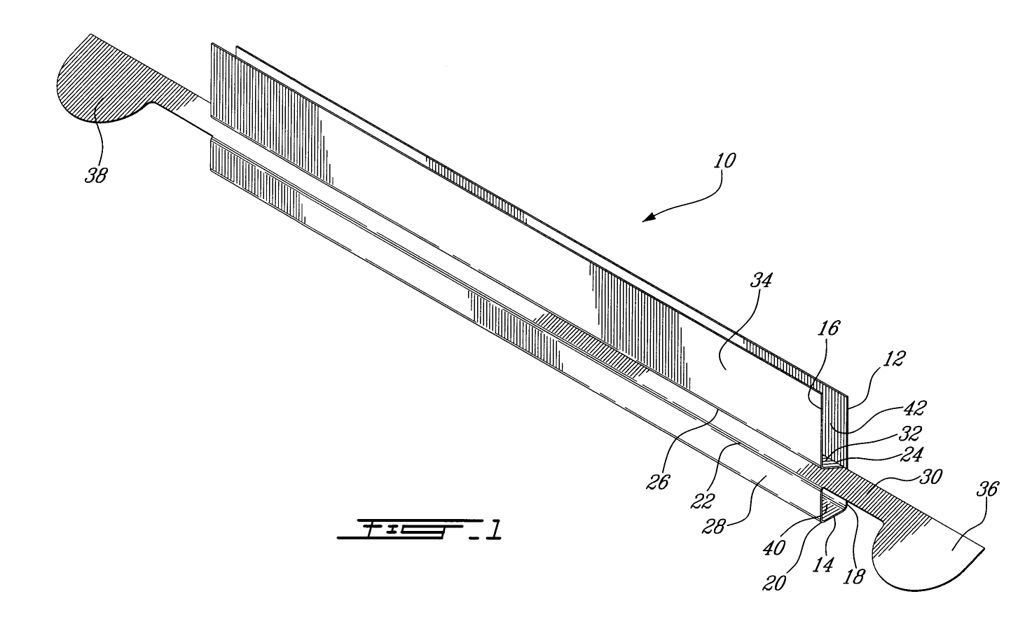

Turning now to FIG. 1 of the appended drawings, a foldable slot liner and interphase insulator combination 10, hereinafter referred to as the slot liner 10, is shown in a perspective view.

The slot liner 10 is a one piece element having a generally U-shape defined by a short side wall 12, a bottom wall 14 and a long foldable side wall 16.

A folding line 18 is present between the short side wall 12 and the bottom wall 14. Similarly, a folding line 20 is present between the bottom wall 14 and the long side wall 16. These two fold lines 18 and 20 enable the general U-shaped of the slot liner 10 to be formed.

The foldable long side wall 16 includes three fold lines 22, 24 and 26 defining four long side wall portions 28, 30, 32 and 34. As will be understood by the present disclosure, the portion 28 insulates a portion of the first coil from the slot wall, the portions 30 and 32 define the interphase insulator and the portion 34 insulates a portion of the second coil from the slot wall.

As is clear from FIG. 1, the portion 30 of the interphase insulator has projections 36 and 38 that extend longitudinally from either ends of the generally U-shaped slot liner. These projections 36 and 38 are configured and sized as to cover the coil heads as will be apparent from the foregoing disclosure. It is to be noted that the illustrated shape of the projections 36 and 38 is for illustration purpose only since the size and shape of these projections are selected to properly cover the coil heads.

Accordingly, the foldable slot liner and interphase insulator combination 10 is so configured that a first coil is insertable in the space 40 defined by the short side wall 12, the bottom wall 14, the portion 28 of the long side wall 16 and the portion 30 of the long side wall 16; while a second coil is insertable in the space 42 defined by the short side wall 12, the portion 32 of the long side wall 16 and the portion 34 of the long sidewall 16.

In other words, the short wall 12 insulates a portion of the first and second coils from one side wall of the slot, the bottom wall 14 insulates a portion of the first coil from the bottom wall of the slot and the long foldable wall 16 insulates portion of the first and second coils from the other side wall of the slot as well and acting as an interphase insulator to insulate the first and second coils from one another.

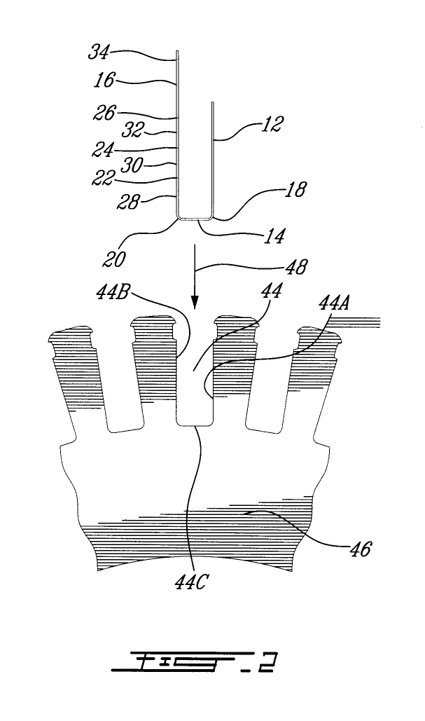

Turning now to FIGS. 2 to 8, the assembly of coils and of a slot liner 10 in the slot 44 of a stator 46 will be described.

FIG. 2 shows the slot liner 10, having its general U-shape thanks' to fold lines 18 and 20, being inserted in the slot 44 of the stator 46 (see arrow 48). The slot 44 being provided with a first wall 44A, a second wall 44B and a bottom wall 44C.

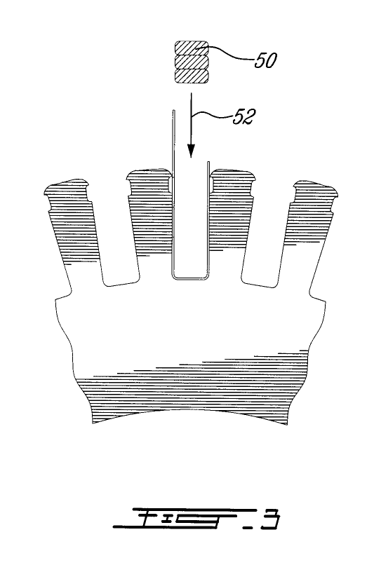

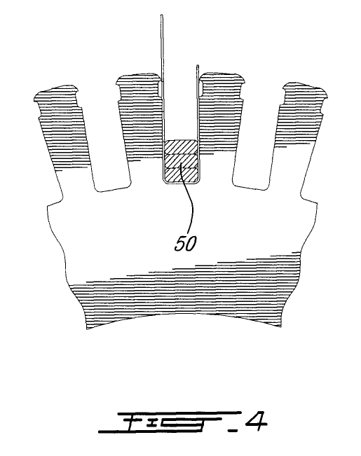

In FIG. 3, a first preformed coil 50 (only a first leg thereof being shown herein) is inserted in the slot liner covered slot (see arrow 52). FIG. 4 shows the result of the first coil insertion.

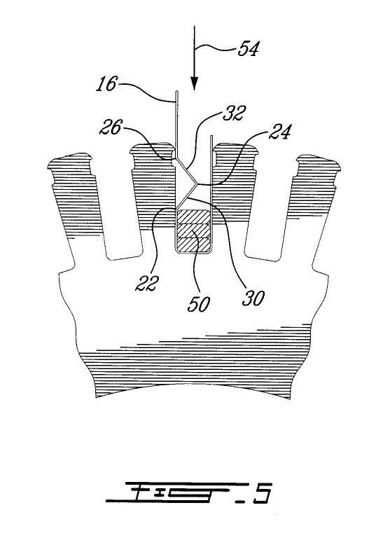

FIG. 5 shows the long side wall 16 being folded to form the interphase insulator. More specifically, a controlled downward force (see arrow 54) is applied to the long side wall 16 so that the portions 30 and 32 are folded along fold lines 22, 24 and 26 to cover the first coil 50.

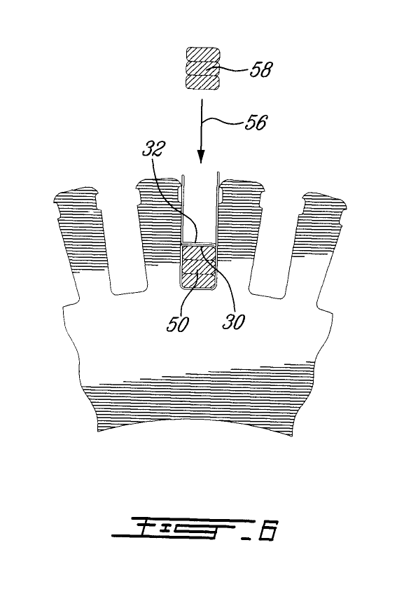

FIG. 6 shows both the result from the folding of the long side wall 16 and the insertion (see arrow 56) of a second preformed coil 58 (only a first leg thereof being shown herein) on top of the interphase insulator (portions 30 and 32 of the long side wall 16).

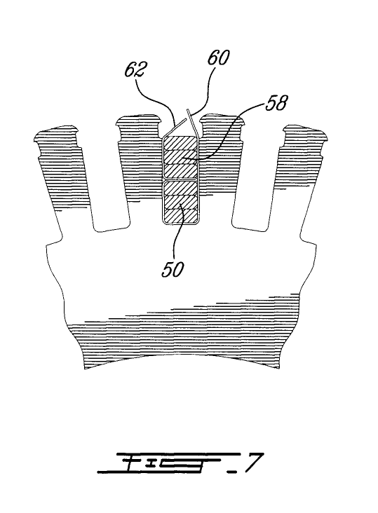

In FIG. 7, the second coil 58 has been inserted and the excess insulation paper from both the short and long side walls shown as the flaps 60 and 62, respectively, are folded on top of the second coil 58 to protect and insulate the exposed portion of the second coil 58.

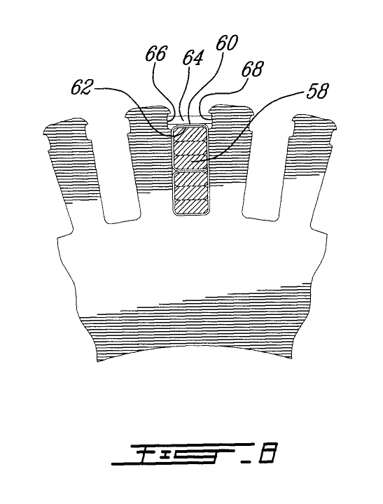

Finally, FIG. 8 illustrates the slot 44 being closed by a slot closing element 64 inserted in notches 66, 68 of the slot 44, and on top of the flaps 60 and 62.

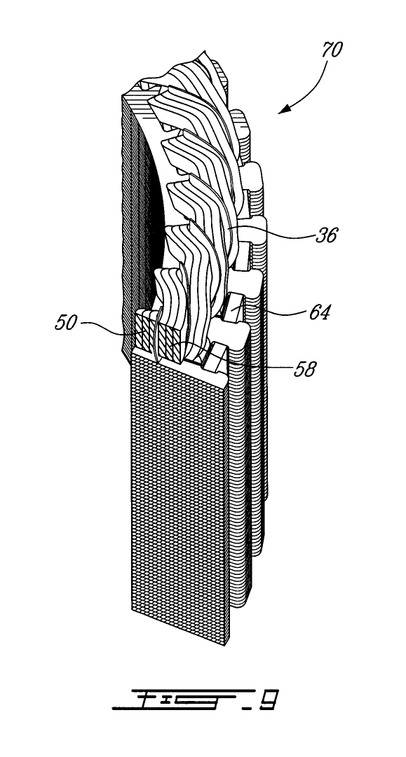

Turning now to FIG. 9 of the appended drawings, a perspective view of a portion of a fully assembled stator 70 provided with slot liners 10 will briefly be described. From this figure, one can see that the legs of each coil are interconnected by curved portion of the conductor forming the coils. These curved portions, generally referred to as heads, are separated by the projections 36 and 38 (only projections 36 shown in FIG. 9) so that heads not belonging to the same coils are not in direct contact but are insulated from one another by the projections.

It is to be noted that the above described operations could be manually performed by an operator or could be partially or totally automated.

It will be understood by one skilled in the art that two supplemental fold lines (not shown) could be provided to ease the folding of the flaps 60, 62 on top of the second coil 58.

It will also be apparent to one skilled in the art that the size and shape of the projections 36 and 38 depends on the size and shape of the coil ends and could therefore be very different from the projections illustrated herein.

It is to be noted that while the slots 44 of the stator 46 are outwardly projecting, other configurations of stator could benefit from the slot liner and interphase insulator combination described herein.

It is also to be noted that while the slot liner described hereinabove is designed to be inserted in the slot of an electric machine sized to receive two coils, slots of electric machines sizes to receive more than two coils could be lined with a similar liner (not shown) including a long side provided with more fold lines to define more than one interphase insulator could be designed.

It is also to be noted that while the slot liners 10 have been illustrated and described hereinabove as being inserted in the stator slots of an external rotor electric machine, the slot liners 10 could be used in a more conventional internal rotor electric machine (not shown). Similarly, while the slot liners 10 have been illustrated and described hereinabove as being inserted in a stator, these slot liners 10 could be used in a wound rotor (not shown).

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of illustrative embodiments thereof, it can be modified, without departing from the spirit, scope and nature of the subject invention.

What is claimed is:

1. A slot liner and interphase insulator made of a insulating material and configured and sized to enter the longitudinal slot of an electric machine and to electrically insulate a first and a second coil from one another and from the electric machine; the insulator comprising:
a short side wall;
a bottom wall; and
a long foldable side wall including three longitudinal fold lines defining first, second, third and fourth long side wall portions;
wherein, when the slot liner and interphase insulator is inserted in the slot of an electric machine, a) the first long side wall portion insulates a portion of the first coil from the electric machine; b) the second and third long side wall portions insulate the first and second coils from one another, and c) the fourth long side wall portion insulates a portion of the second coil from the electric machine.

2. The slot liner and interphase insulator recited in claim 1, further comprising a fold line separating the short side wall and the bottom side wall.

3. The slot liner and interphase insulator recited in claim 1, further comprising a fold line separating the bottom wall and the long foldable side wall.

4. The slot liner and interphase insulator recited in claim 1, wherein the slot liner and interphase insulator is made of insulating paper material.

5. The slot liner and interphase insulator recited in claim 1, wherein at least one of the second and third long side wall portions includes a longitudinal projection so configured and sized as to cover the coil heads to insulate the heads of the first and second coils from one another.

6. The slot liner and interphase insulator recited in claim 1, wherein the longitudinal slot is present in the stator of the electric machine.

7. The slot liner and interphase insulator recited in claim 1, wherein the longitudinal slot is present in the rotor of the electric machine.

8. A slot liner and interphase insulator made of an insulating material and configured and sized to enter the longitudinal slot of an electric machine to electrically insulate a first and a second coil from one another and from first and second side walls and a bottom wall of the longitudinal slot, the insulator comprising:
a short side wall so configured and sized as to insulate the first side wall of the slot;
a bottom wall so configured and sized as to insulate the bottom wall of the slot; and
a long side wall so configured and sized as to insulate the second side wall of the slot and to be folded to define an interphase insulator insulating the first and second coils from one another.

9. The slot liner and interphase insulator recited in claim 8, wherein the long side wall includes three longitudinal fold lines defining first, second, third and fourth long side wall portions;
wherein, when the slot liner and interphase insulator is inserted in the slot of an electric machine, a) the first long side wall portion insulates a portion of the first coil from the electric machine; b) the second and third long side wall portions insulate the first and second coils from one another, and c) the fourth long side wall portion insulates a portion of the second coil from the electric machine.

10. The slot liner and interphase insulator recited in claim 8, further comprising a fold line separating the short side wall and the bottom side wall.

11. The slot liner and interphase insulator recited in claim 8, further comprising a fold line separating the bottom wall and the long foldable side wall.

12. The slot liner and interphase insulator recited in claim 8, wherein the slot liner and interphase insulator is made of insulating paper material.

13. The slot liner and interphase insulator recited in claim 9, wherein at least one of the second and third long side wall portions includes a longitudinal projection so configured and sized as to cover the coil heads to insulate the heads of the first and second coils from one another.

14. The slot liner and interphase insulator recited in claim 8, wherein the longitudinal slot is present in the stator of the electric machine.

15. The slot liner and interphase insulator recited in claim 8, wherein the longitudinal slot is present in the rotor of the electric machine.
